(19) United States
(12) Patent Application Publication
(10) Pub. No.: US 2009/0063383 A1
(43) Pub. Date: Mar. 5, 2009

(54) Real-time reasoning system using natural language-like rules

(76) Inventors: Norman Beaulieu, Cambridge, MA (US); Kuang-Jung Huang, Cary, NC (US)

Correspondence Address: LAHIVE & COCKFIELD, LLP;FLOOR 30, SUITE 3000, ONE POST OFFICE SQUARE, BOSTON, MA, 02109, US

(21) Appl. No.: 12/152,072

(22) Filed: May 12, 2008

Related U.S. Application Data
(60) Provisional application No. 60/928,717, filed on May 11, 2007.

(51) Int. Cl. G06N 5/02

(52) U.S. Cl. 706/47

(57) ABSTRACT

A reasoning system with a reasoning engine that uses a rule set created from a rule representation language that has an English/natural language-like rule syntax and format is discussed. The reasoning system employs a real-time selection algorithm that chooses the rules used to analyze complex data (e.g.: bio-medical research, e-commerce, Customer Relationship Management (CRM), environmental research & engineering, bio-chemical research and product development, Investment and money management, anything related to research and product development) without suffering exponential performance decreases as the complexity of the analysis increases. The use of the rule representation language enables different domain users to review, create and modify rules without requiring the users to possess an advanced knowledge of programming languages.

### RELATED APPLICATION

The present application claims the benefit of U.S. Provisional Patent Application No. 60/928,717, filed on May 11, 2007, the content of which is incorporated by reference in its entirety.

### FIELD OF THE INVENTION

The embodiments of the present invention relate generally to reasoning systems, and more particularly to the use of a real-time reasoning system using a natural language-like syntax and format.

### BACKGROUND

Reasoning systems apply axiomatic knowledge present in a knowledge base to task-specific data to arrive at conclusions. For example, a bio-medical researcher may use a reasoning system to apply rules to identify conclusions within a gene database. Reasoning systems for traditional knowledge-based reasoning employ exhaustive methods that find every conclusion possible based on a given set of premises. This conventional kind of reasoning system is used for instance for diagnoses where all possible outcomes based on a given input are under consideration.

Unfortunately, there are a number of drawbacks implicit in the use of conventional reasoning systems. One drawback is that the exhaustive reasoning methods performed by conventional reasoning systems to find every possible conclusion do not scale well. The conventional reasoning engines take exponentially longer to find solutions as the data being examined grows in volume and the analysis grows in complexity. The conventional reasoning systems therefore tend to only be practical to use when the number of possible outcomes is small. Another problem with conventional reasoning systems stems from their systems use of a high-level programming language syntax and format that make it difficult for researchers to review and adjust rule sets being applied to problems. The use of high-level programming languages makes it difficult for a user to create and to modify rules as needed since a detailed understanding of the programming language being used is ordinarily required. Many users of reasoning systems are proficient in specific types of domain knowledge but often lack programming expertise which makes it hard to translate domain knowledge into the rules needed for a reasoning system.

### BRIEF SUMMARY

The embodiments of the present invention provide a reasoning system with a reasoning engine that uses a rule set created from a rule representation language that has an English/natural language-like rule syntax and format. The reasoning system employs a real-time selection algorithm that chooses the rules used to analyze complex data (e.g.: bio-medical research) without suffering exponential performance decreases as the complexity of the analysis increases. The use of the rule representation language enables different domain users to review, create and modify rules without requiring the users to possess an advanced knowledge of programming languages.

In one embodiment of the present invention, a computing device-implemented method for providing real-time reasoning includes the providing of a reasoning engine. The real-time reasoning engine supports the use of a rule representation language that has a natural language-like syntax and format. The rule representation language is used to form a rule set with at least one rule. The method also provides a real-time selection algorithm in the reasoning engine. The real-time selection algorithm programmatically selects one rule from the rule set in one reasoning cycle. At the completion of the reasoning cycle, one conclusion is then identified using the reasoning engine.

In another embodiment of the present invention, a system for identifying conclusions within a collection of data includes a collection of data and a reasoning engine. The real-time reasoning engine supports the use of a rule representation language that has a natural language-like syntax and format. The reasoning engine also includes a real-time selection algorithm that programmatically selects at least one rule written in the rule representation language from a rule set. The selected rule is used by the reasoning engine to identify at least one conclusion within a collection of data. The system also includes a user interface. The user interface displays the identified at least one conclusion and the selected rule(s) used in identifying the conclusion(s).

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 depicts an environment suitable for practicing an exemplary embodiment of the present invention;

FIG. 2 depicts an exemplary selection algorithm employed by the reasoning engine;

FIG. 3 is a flowchart of an exemplary sequence followed by an embodiment of the present invention to identify conclusions in a collection of data; and

FIG. 4 is a flowchart of an exemplary sequence followed by an embodiment of the present invention to create rules using a rule representation language with a natural language-like syntax.

FIG. 5 depicts an alternate distributed environment suitable for practicing an exemplary embodiment of the present invention;

### DETAILED DESCRIPTION

The embodiments of the present invention provide a reasoning system used to identify conclusions based on an analysis of one or more data stores. The reasoning system may be used for many purposes including performing prediction, simulation, recommendation, personalization, and/or analysis in varied domains such as clinical trials, protein/gene pathway analysis, environmental engineering, e-commerce, and investing based on the type of problem being solved. The reasoning system utilizes a reasoning engine which includes a real-time selection algorithm and also supports the use of a rule representation language that has a natural language-like syntax and format. The use of the rule representation language with the natural language-like syntax and format helps to bridge the gap between the domain knowledge of researchers and scientists and the programming knowledge required to create rules in conventional reasoning systems. The rule representation language allows users to create and modify reasoning rules so as to form a rule set that expresses their domain knowledge. The selection algorithm then selects and applies only a subset of the available rules from the rule set as part of the reasoning cycle used to identify conclusions in the collection of data. The reasoning engine displays the conclusions that have been identified and those rules that were selected and used to identify the conclusions. Because the selected rules were created from the rule representation language, the rules are displayed in a form that is understandable to a user not skilled in programming languages and may therefore be modified or replaced as deemed necessary by the user.

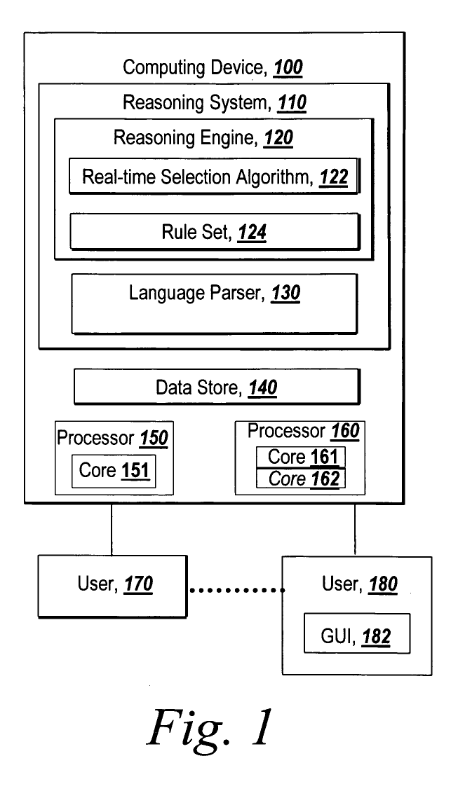

FIG. 1 depicts an environment suitable for practicing an exemplary embodiment of the present invention. A computing device 100 hosts a reasoning system 110. The computing device 100 may be a workstation, server, laptop, mainframe, PDA or other computing device equipped with one or more processors 150 and 160 that have one or more cores 151, 161 and/or 162 and that is able to support the reasoning system 110. The reasoning system 110 is implemented as software that identifies conclusions for a data store 140. The data store 140 may be hosted by the computing device 100 and/or may be stored at a location accessible from the computing device. The data store 140 may be a gene database, stock information or some other form of data. The reasoning system 110 includes a reasoning engine 120 and supports the use of a rule representation language that has a natural language-like syntax and format. The reasoning engine 120 includes a real-time selection algorithm 122 and includes, or has access to, a rule set 124 that includes rules parsed by the language parser 130. The real-time selection algorithm 122 selects a subset of available rules from the rule set 124 and iteratively applies the selected rules to identify conclusions for the data store 140 transition.

A user 170 may view output from the reasoning system 110 on a graphical user interface (GUI) 182 generated on a display device 180 that is in communication with the computing device 100. The output may include both the identified conclusion(s) and the applied selected rules.

In order to identify one or more conclusions for a collection of data, the reasoning engine 120 applies rules representing domain knowledge to a specified data store 140. The particulars of the rules will vary with the domain. For example, when the data store 140 is a collection of information about biological pathways, the rules may specify various types of pathway connections. As noted above, many conventional reasoning systems exhaustively apply rules to determine every possible outcome. In contrast, in order to facilitate real-time responses for the reasoning system 110, the embodiments of the present invention use a real-time selection algorithm 122 in the reasoning engine 120 to identify conclusions for a data store 140. The reasoning engine applies heuristic criteria to limit the number of rules in working memory. For example, the real-time selection algorithm 122 may maintain only a specified amount of the most recently used and highest priority rules from the rule set 124 during the reasoning cycle. Therefore, in each reasoning cycle, the reasoning engine 122 only has to reason through a small amount of rules in order to respond in a timely manner.

In one embodiment, the reasoning system relies upon forward chaining to conduct the reasoning using the current rule set which is written in an if-then-else format. The forward chaining starts with the available data and applies the selected rules to extract more data until a goal is reached. The reasoning engine searches the selected rules until a rule is identified for which the “if” clause is known to be true. The reasoning engine may then infer or conclude the “then” clause. The reasoning engine may continue to analyze iteratively until a goal is reached. The reception of new data can trigger new inferences/conclusions.

The real-time selection algorithm modifies the traditional reasoning engine's recognize-act cycle to guarantee a real-time response for complex reasoning. The real-time selection algorithm may only select rules assigned a certain priority and may give preference to those rules least recently used in working memory. The preference for those rules least recently in working memory helps to prevent starvation of similarly prioritized rules.

In one embodiment, the real-time selection algorithm may be represented as:

if conflict set is empty { // no conflict set at all

Set selected rules to be empty

else

// Step 1: Adjust the size of the conflict set
Set original size to be the same as the size of the conflict set;
Calculate reduced size using original size * (100-upper bound)/100;
Reduce the size of the conflict set to reduced size;
// Step 2: Find the rule with most recent Working Memory Element
For every conflict in the conflict set

Compare the time stamp on the conflict set to find the
most recent one

If there is no conflict found

Stop rule engine

In other words, the conflict set of rules is reduced in size and the reduced size conflict set is then evaluated to determine which rules “if” statements evaluate to “true”. Where more than one rule evaluates to true, the time stamp for the rules are compared and the least recently used rule is selected. It will be appreciated that this selection process may also be combined with an examination of a priority attribute assigned to each rule.

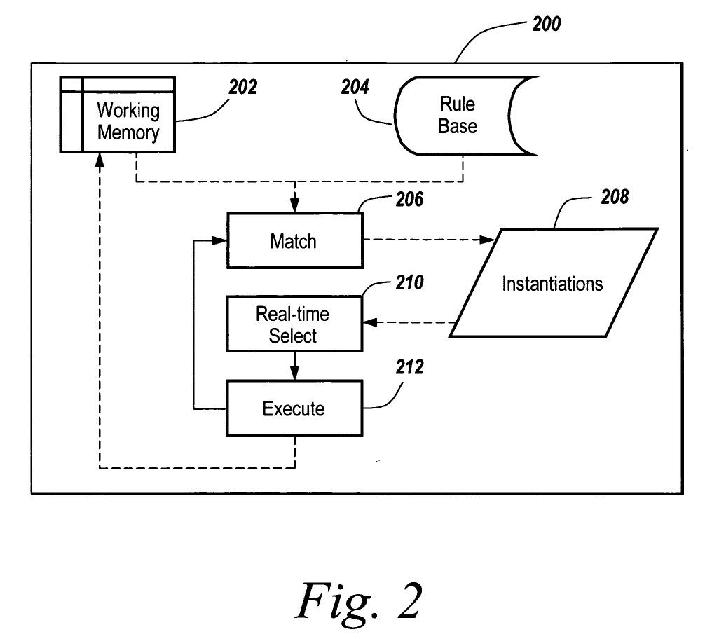

FIG. 2 depicts an exemplary selection algorithm employed by the reasoning engine. The selection algorithm allows the data store to be analyzed using fewer rules than are utilized in conventional reasoning systems. The collection of data in working memory 202 is compared with a rule set/rule base 204 to determine matches 206 where the “if” statements in the rule evaluate to “true”. Object instantiations 208 define individual objects with values for attributes. As will be explained further below, rules act on data contained within object attributes. The real-time selection algorithm 210 then limits the number of rules being applied by winnowing the rule conflict set as discussed above. The reduced subset of rules is then executed 212 to analyze the collection of the data in working memory 202. Each analysis iteration may add to the knowledge set. The overall reasoning sequence may continue until a specified goal has been reached.

In addition to the real-time selection algorithm, the embodiments of the present invention also support the use of a rule representation language with an English/natural language-like syntax and format. The purpose of a natural language-like rule syntax is to allow rule writers to write down their domain knowledge using a language that most closely resembles the English language. This leads to the ability of researchers to more efficiently translate their domain knowledge into rules that can be applied by the reasoning system. Because the rules are reduced to an English-like state, they can be leveraged across disciplines and can lead to the integration of data sets from different disciplines. For example, large companies with many different ongoing projects in different divisions may be able to integrate data sets. A parser for the rule representation language in the reasoning engine transforms those rules into the internal data representation needed to start the reasoning engine.

In one embodiment, the rule representation language has four basic categories of syntax: object definitions, object associations, object instantiations, and rules.
Object definitions define the objects used within the script.
Object associations define object aliases.
Object instantiations define individual objects with values for its attributes.
Rules define object relationships in the form of conditions that must be satisfied and actions to take if those conditions are met.
   The sections to follow will describe the rule definition syntax. It should be appreciated that the definitions below represent illustrative embodiments and different rule definition syntax's are also considered within the scope of the present invention. An example of the notation is as follows:
(X|Y|Z) ({A}|({B}'s {C})), M [(, | and) N]
   This example contains all of the syntactical elements used herein:

(1) Brackets (i.e., {}) define required script items. This can include keywords, actions, objects and attributes of objects.

(2) Bars (i.e., |) define a choice. Often these choices are user preferences.

(3) Parentheses (i.e., ( ) ) group script items. Often they group choices.

(4) Square Brackets (i.e., [])define optional syntax. Note that the syntax within is repeatable.

Therefore, valid syntax for the above example is:
Y {B}'s {C}, M, N and O
   The following sections will define the four basic categories of syntax defined above. In addition, the syntax for the condition and action parts of rules will be described.

1. Object Definition
Rules act on data contained within object attributes. Object attributes can have various datatypes (i.e., string, boolean, integer, float and character). An object name can be an alphanumeric combination of one or more words (e.g., person, person1, person_name, person-name, or person name). The same is also true for object attributes (e.g., name, name1, last_name, last-name, or last name). Note that object and object attribute names cannot contain keywords (e.g., “my attribute” where “attribute” is a keyword). However, a hyphenated or underscored word concatenation is acceptable (e.g., my-attribute).
The object definition section of the script is identified by the term “Declarations:”

### Syntax

Declarations:
((attribute[s](of | for) {object})|({object}'s attribute s])) (is | are) {attribute}[(, | and){attribute}]

### Example

In this and all of the subsequent examples, keyword words are indicated in italic typeface.
Declarations:
Attributes of person are name, city, age and gender;
Person's attributes are name, city, age and gender;
Here an object called person has attributes of: name, city, age and gender. Another example object is a car object:
Attributes of car are maker, model name, model year, color;
Car's attributes are maker, model name, model year, color;

2. Object Associations
This script supports object aliases. In essence, it's an alternate name for an object. In an object-oriented environment, this would be a sub-classed object. Note that object associations are also defined within the “Declarations” section of the script.

### Syntax

{object alias} is (a | an) {previously defined object}

### Example

The following is an example of an object association. Here, a man and woman assume the attributes defined for a person object.
Man is a person;
Woman is a person;
Macintosh is an apple;

3. Predefined Objects
In one embodiment, there are three predefined objects—List, Matrix, and Database. List and Matrix are defined to allow array-like activities. Database object is used to import the data from an external database source to rule representation language objects.

### List

List contains two attributes—size and value. Size is used to indicate the current size of the list. Value is used to store the elements of the list. The elements of the list may be enclosed using “[” and “]”. All elements are separated by a comma. The list could be initialized with less initial values.

### Example

make list1 size is 10, value is [1,2,3,4,5,6,7,8,9,10];
make list2, size is 5, value is [“a”, “b”, “c”, “d”, “e”];
make list3, size is 4, value is [0];
list1[1] = list1[2] + list1[3];
list[pro's count]=list[pro's count] + 2;
list1 = list2;

### Matrix

Matrix contains three attributes—rowSize, columnSize, and value. rowSize is used to indicate the row size of the matrix. columnSize is used to indicate the column size of the matrix. Value is used to store the elements of the matrix. The elements of the matrix shall be enclosed using “[” and “]” just like the list with nested notation. All elements are separated by a comma. Same as List, Matrix could be initialized with less initial values.

### Example

make matrix1, rowSize is 2, columnSize is 2, value is [[1,2],[3,4]];
make matrix2, rowSize is 3, columnSize is 2, value is [[“a”, “b”], [“c’,
“d”], [“e”, ”f”]];
make matrix3, rowSize is 4, columnSize is 3, value is [[0],[0]];
matrix1[0,0] = matrix1[0,1] − matrix1[1,1];
matrix1[pro's count, pro's number] =1;
matrix1 = matrix2;

### Database

The Database does not contain any attributes. A Database object can be used to define an entry of a database table. To do so, a user has to define the database description in the database.properties file under the cfg folder. There are two items for each database object—database location and default query. For example, if the user wants to define a database object called “entry”, then the following names need to be defined in the database.properties file:

entry1=jdbc:mysql://localhost/geno?user=root&password=
entry1Query=select * from geno

The first item describes the location and connection parameter for the database. The second item is the default query if the user does not provide the query statement at all.

### Tool

Same as Database, Tool does not contain any attributes (Its attributes are used internally by DESCARTES). A Tool object can be used to define an entry of a third party tool. To do so, a user has to define the tool description in the tool.properties file under cfg folder. There are three items for each tool object—url location, query parameter, and return string separator. For example, if a user wants to define a tool object called “blast”, the following names need to be defined in the tool.properties file:

blast= http://www.ncbi.nlm.nih.gov/BLAST/Blast.cgi
blastParameter=
CMD=Put&DATABASE=nr&HITLIST_SIZE=10&FILTER=L&EXPECT=10&FOR
MAT_TYPE=TEXT&PROGRAM=blastn&CLIENT=web&SERVICE=plain&NCBI_{—}
GI=on&PAGE=Nucleotides&QUERY=
blastSeparator=<>

The first item describes the url location for the tool. The second item is the default parameter for the tools. The third item is the separator that will be used to separate the query string into different items stored in the list or objects.

### Object Instantiations

Object instantiation syntax creates an object in the working memory and assigns a value to some or all of its attributes. Within the rule representation language, these instantiations are referred to as “facts”. Like object and object attribute names, values can be an alphanumeric combination of one or more words (e.g., Joel, Joel1, Joel_Chou, Joel-Chou, or Joel Chou). The same is true that values cannot contain keywords (e.g., “Make Car” where “make” is a keyword). However, a hyphenated or underscored word concatenation is acceptable (e.g., make-car).
The object instantiation section of the script is identified by the term “Facts:”

### Syntax

Facts:
(Create | Make) {object}, {attribute} is {value}[(, | and) {attribute} is {value}]

### Example

Here two person objects are defined.

### Facts:

Create person, name is Dan and gender is male;
Make person, name is Joel;

4. Rules
Each rule contains a set of conditions that must be satisfied and a set of actions to take if those conditions are met. Within the rule definition syntax, the conditions are the “if” part of the rule whereas the actions are the “then” part of the rule. So, a rule literally reads: if the following conditions are true, then perform the following actions. Each rule is identified by a unique name. If the scriptwriter does not define a name, then rule representation language parser will automatically assign a name.
Like the others, rules can be an alphanumeric combination of one or more words (e.g., FindOldCar, Find old car1, find_old_car, find-old-car, or Joel Chou). The same is true that rules cannot contain keywords (e.g., “Car is old” where “is” is a keyword). However, a hyphenated or underscored word concatenation is acceptable (e.g., car_is_old).
The rule section of the script is identified by the term “Rules:”

Syntax

Rule [{rulename}]
If
{set of conditions}
Then
{set of actions}

### Example

### Rules:

Rule find old fords
If
Car's maker = Ford;
Car's age > 6;
Then
Write “%s, made by %s, is old (%i years old)\n”, car's model name,
car's maker,
car's age;

General Rule Syntax
The following syntax applies to both condition and action statements.

### Elements

Each condition or action statement is an element. An element may involve multiple objects. An element can span multiple lines. A semi-colon (;) is used to indicate the end of an element.

In one embodiment, each element may only represent one condition or action as defined below in (1). In another embodiment, multiple condition statements for the same object as defined below in (2) are allowed. Note that the multiple condition statements are treated as conjunctions.

Syntax

| | |
|---|---|
| 1. | (({attribute} (of \| for) {object}) \| ({object}'s {attribute})) {equality |
| | operator} |
| | (({attribute} (of \| for) {object}) \| ({object}'s {attribute}) \| |
| | <variable> \| value) |
| 2. | (({attribute} (of \| for) {object}) \| ({object}'s {attribute})) {equality |
| | operator} |
| | (({attribute} (of \| for) {object}) \| ({object}'s {attribute}) \| |
| | <variable> \| value) |
| | [(; \| and) {attribute} {equality operator} (({attribute} (of \| for) |
| | {object}) \| ({object}'s {attribute}) \| <variable> \| value)] |

### Example

Car's maker is Ford;
Car's maker is Ford; color = “Blue” and age <= person's age;

### Comment

Two types of comments are supported.

### Syntax

Single line commenting {// . . . }
Multi-line commenting {/* . . . */}

### Example

// This is a single line comment
/* This is a multi-

line comment */

### Constant Values

Constant values can be either a string or a number. Note that string constants are case sensitive and double quotes are optional. But, double quotes may be required to use keywords or attributes of objects within the string.

### Example

“Foo Bar”
Foo Bar
5

### Equality Operators

An equality operator compares the statements on either side of the operator and produces a boolean result. For example, the condition “car's maker is Ford” has an equality operator of “is”. The operator will produce a “true” result when the maker attribute of the car object equals the string “Ford”. Otherwise, the result will be “false”.

### Syntax

The following equality operators are supported:

(1) Equal to (equal to | is |=)

3. Not equal to (not equal to | is not |!=)

4. Less than (less than |<)

5. Less than or equal to (less than or equal to |<=)

6. Greater than (greater than |>)

7. Greater than or equal to (greater than or equal to >=)

### Example

Person's name is equal to “Michael”;
Person's name is Joel Chou;
Person's age <10;

### Negation: is not

Negation of all equality operators may be supported.

Syntax

(({attribute} (of | for) {object}) | ({object}'s {attribute})) {inequality
operator}
(({attribute} (of | for) {object}) | ({object}'s {attribute}) | <variable> |
value)

### Example

Name of person is not Joel and age of person is not greater than 25;
Car's age is not greater than or equal to 30;
Name of person is <name> and room number is not null;

### in Operator

in Operator is used to perform equality match in all attributes in an object (including list and matrix).

### Syntax

value {in operator} {object}

### Example

“id=5” in Current_page;
“abc” in list1;
“123” in matrix1;

### Arithmetic Operators

Arithmetic operators are supported.

### Syntax

The following arithmetic operators are supported:

(2) Addition {+}

8. Subtraction {−}

9. Multiplication {*}

10. Division {/}

11. Modulus {%}

12. Power {̂}

13. Parentheses {( )}

Note that the arithmetic order of precedence is also supported. That is, operators are evaluated in the following order: parenthesis, {multiplication | division | modulus}, {addition | subtraction}, powers.

### Example

Person's age>(man's age+woman's age*1.4)̂(man's height/woman's height);

### Variable Assignment

Variables provide a means to temporally-define a value within a rule. In other words, variables have persistence only within the rule defining the variable.

### Syntax

<variable name>=({symbol}|{formula})

### Example

<x> = “This is a string”;
<x> = <y> * car's age + 1;
<temp> = age of person;
<calculated value> = car's age * 2;

### Null Value

Null values are supported.

### Syntax

(empty | null)

### Example

Car's name is empty;
Person's age is null;

### Functions

The rule representation language may support the following functions; substring, length, gap, and search. They can be used in the conditions or actions of the rule portion of the scripts.
   substring function

### Syntax

substring(string, int, int)
substring function takes three parameters. First parameter—string is the target string for extracting the substring. Second parameter—int indicates the starting index. The last parameter—int indicates the ending index.

### Example

substring(“abcd”,0,2) - the result of this functions is “ab”
substring(visit_log's file,0,1)
substring(visit_log's file,1,length(visit_log's file))

length function

### Syntax

length(string)
length function returns the size of the string. It takes one parameter—string indicates the target string for evaluating the size.

### Example

Length(“abcd”) - the result of this function is 4
length(visit_log's file)

gap function

### Syntax

gap(string, string, string)
gap function returns the distance of the two substrings (if they do exist in the target string) in the target string. It takes three parameters. First parameter—string is the target string for calculating the distance of two substrings. Second parameter—string indicates the first substring. The last parameter—string indicates the second substring.

### Example

gap(“abcdefef”,”ab”,”ef”) - the result of this function is 4
gap(“abcdefef”,“ab”,”eg”) - the result of this function is −1
gap(geno's string,<pattern1>,<pattern2>)

search function

### Syntax

search(string, string)
search function returns the position of the substring (if it does exist in the target string) in the target string. It takes two parameters. First parameter—string is the target string for finding the substring. Second parameter—string indicates the substring with regular expression format to be located in the target string.

### Example

search(“abcdefef”,”ab”) - the result of this function is 0
search(“abcdefef”,”cd”) - the result of this function is 2
search(“abcdefef”,”ef”) - the result of this function is 4
search(“abcdefef”,”ac”) - the result of this function is −1
search(“abcdefef”, “b.d”) - the result of this function is 1 (“b.d” is a
regular expression)
search(geno’s string,<pattern>)

split function

### Syntax

split(string, string)
split function returns a list from the target string separated from the delimiter which is a regular expression. It takes two parameters. First parameter—string is the target string to be separated. Second parameter—string indicates the separator with regular expression format to be separated in the target string.

### Example

split(“ab:cd:ef:ef”,”:”) - the result of this function is [“ab”,”cd”,”ef”,”ef”]
split(“11-10-03 12:09:08”,”[:-]”) - the result of this function is
[“11”,”10”,”03”,”12”,”09”,”08”]

### Condition Statements

The following syntax applies only to condition statements.

### Conjunction: and

unctions are used to join two equality operators.

### Syntax

(({attribute} (of | for) {object}) | ({object}'s {attribute})) {equality
operator} {value} and {equality operator} {value}

### Example

Person's age is greater than 18 and less than 30;
Capacity of room is <capacity>, vacancies are greater than 0 and less than <capacity>;

### Disjunction: or

Disjunctions are primarily used with values. The only other occasion to use a disjunction is to verbally represent >=(i.e., greater than or equal to) and <=(i.e., less than or equal to).

### Syntax

(({attribute} (of | for) {object}) | ({object}'s {attribute})) {equality
operator}
(({attribute} (of | for) {object}) | ({object}'s {attribute}) | <variable> |
value) [(, | or)
(({attribute} (of | for) {object}) | ({object}'s {attribute}) | <variable> |
value)] or
(({attribute} (of | for) {object}) | ({object}'s {attribute}) | <variable> |
value)

### Example

Capacity of room is 2 or 3 or <temp>;
Capacity of room is 2, 3 or <temp>;

### Range

Range provides an upper and lower bounding of variables. The bounding is inclusive.

Syntax

(({attribute} (of | for) {object}) | ({object}'s {attribute})) range[s]
from (({attribute}
(of | for) {object}) | ({object}'s {attribute}) | <variable> | value) to
(({attribute} (of |
for) {object}) | ({object}'s {attribute}) | <variable> | value)

### Example

Car's age ranges from 3 to person's age;
Person's name ranges from “Jones” to <temp>;

### Action Statements

The following syntax applies only to action statements.

### Create Fact

Dynamic addition of facts to the working memory may be supported.

### Remove Fact

Dynamic deletion of facts from working memory may be supported. The remove operation can also contain a condition statement.

Syntax

(Remove | Delete) (<variable designator> | {object}) [, (who's | whose |
where)
{attribute} {equality operator} (({attribute} (of | for) {object}) |
({object}'s
{attribute}) | <variable> | value) [(, | and | or) {attribute} {equality
operator}
(({attribute} (of | for) {object}) | ({object}'s {attribute}) | <variable> |
value)]]

### Example

Remove person;
Remove <Name>;
Remove person, who's gender is male and room number is not null;
Remove person, whose name is Joel or Michael;
Remove car, where age is equal to person's age;

### Change Fact

Dynamic modification of attribute values of objects in working memory may be supported.

Syntax

(Set | Modify | Change) ((<variable designator>, {attribute}) | ({attribute}
(of | for)
{object}) | ({object's {attribute})) to (({attribute} (of | for) {object}) |
({object}'s
{attribute}) | <variable> | value) [(, | and) {attribute} to (({attribute}
(of | for)
{object}) | ({object}'s {attribute}) | <variable> | value)]

### Example

Modify <Name>, name to Danny and room number to 12;
Set person's name to Danny and room number to 12;

### Open a File

Opening a text file for reading and writing may be supported. There are three modes in which to open a file: as input to read data; as output to overwrite data; or as append to add data to the data currently in the file. If a mode is not specified, the default mode is input.

### Syntax

Open {file name} [as (input | output | append)]

### Example

Open filename. txt;
Open filename. txt as input;

### Close a File

Closing an open text file may be supported.

### Syntax

Close {file name}

### Example

Close filename. txt;

### Output to a File or Screen

Writing formatted and unformatted strings to the screen or a file may be supported. In one embodiment, the following datatype formatting is supported: % c (character), % s (string), % i (integer), % f (float).
Note that if a user does not “open” a file prior to the write command, the file may be automatically opened as “append”. Once written to, the file may be automatically closed.

Syntax

write ({string} | ([{formatting string},] (({attribute} (of | for) {object}) |
({object}'s {attribute}) | <variable>)) [, (({attribute} (of | for) {object}) |
({object}'s {attribute}) | <variable>)]) [to {file name}]

### Example

### Formatted Output

Output to a File
Write “single_entry % s: % s: % i \n”, <in>, car's name, <number> to output. txt;
Screen Output
Write “single_entry % s: % s: % i \n”, <in>, car's name, <number>;

### Unformatted Output

Output to a File
Write <in>, car's name, <number> to output.txt.

### Screen Output

Write “Hello World!!\n”;
Write <in>, car's name, <number>;
   Read Input from a File or Screen
Reading unformatted strings from the screen or a file may be supported. Users can specify the delimiters used to separate the individual input.
Note that if a user does not “open” a file prior to the read command, the file will be automatically opened as “input”. Once read from, the file may be automatically closed.
While reading data from an input file, each record should be separated into lines.

Syntax

read [{delimiter string}] (({attribute} (of | for) {object}) | ({object}'s
{attribute}) | <variable>) [, (({attribute} (of | for) {object}) | ({object}'s
{attribute}) | <variable>) [from {file name}]

### Example

### Formatted Input

Read from a File using space as separator
Read “”, person's name, person's age, person's height from input.txt;
Read from a File using comma as separator
Read “, ”, person's name, person's age, person 's height;
   Import Object from a Database Source or Third Party Tool
Importing objects (including regular objects, matrix, and list) from a database source or third party tool may be supported. In one embodiment, MYSQL and mSQL database systems are supported in the rule representation language. It should be noted that a user does not supply the “using phrase” at the end of the import command. The default query string from the database.properties or tool.properties in the cfg folder will be used.

### Syntax

import {object} from {database object | tool object}[using {query string}]

### Example

### Formatted Input

Import A Matrix From A Database Using A Select Query String
Import matrix1 from entry1 using “select * from geno”;
Import A List From A Database Using A Select Query String
Import list1 from entry2 using “select name, number from geno”;
Import An Object From A Database Using A Select Query String
Import object from entry2 using “select name, number, weight from geno”;
Import A List From A Database Without Query String
Import list1 from entry2;

The reasoning system of the present invention accumulates and manages knowledge that can be reused to run future applications due to the English-like rules. These English-like rules can be modified or reused easily because their meaning can be interpreted quickly just like regular English.

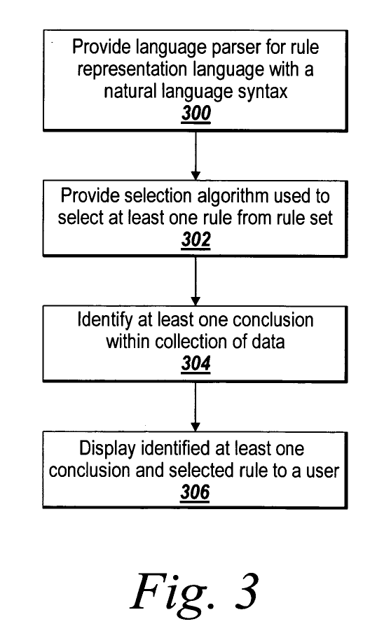

FIG. 3 is a flowchart of an exemplary sequence followed by an embodiment of the present invention to identify conclusions in a collection of data using the natural language-like rules. The sequence begins with the provision of a language parser for a rule representation language with natural language like syntax and format (step 300). A selection algorithm which is used to select at least one rule written in the rule representation language is also provided (step 302). At least one conclusion/inference is identified for a collection of data by the reasoning engine (step 304) and the identified conclusion and the rule or rules selected and used to identify the conclusion are displayed to a user (step 306). The display of the selected rules in a natural language-like syntax provides an opportunity for a user to review the rules used to identify the conclusions.

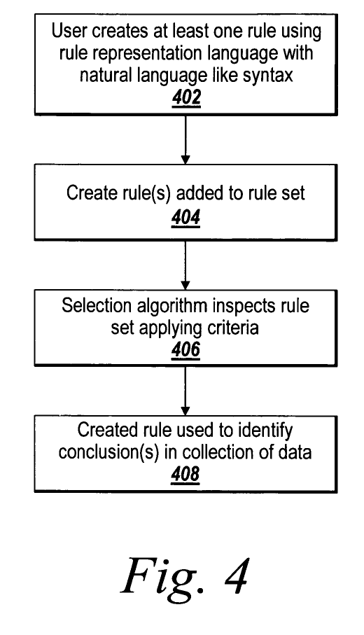

Once reviewed, the natural language-like rules may be modified or added to based upon the user's wishes. FIG. 4 is a flowchart of an exemplary sequence followed by an embodiment of the present invention to create rules using a rule representation language with a natural language-like syntax. The sequence begins when the user creates at least one rule using the rule representation language with natural language-like syntax (step 402). The created rule is then added to the existing rule set (step 404). The real-time inspection algorithm then subsequently inspects the rule set applying its heuristic criteria for selection (step 406). When selected, the created rule is used to identify conclusions for a collection of data (step 408).

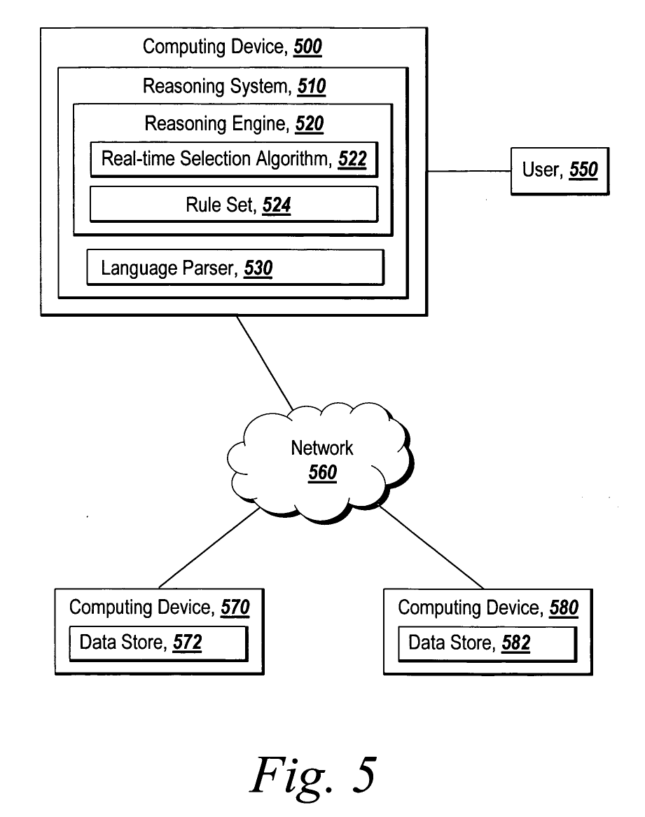

It will be appreciated that embodiments of the present invention may be practiced in a number of differently configured environments including the alternate distributed environment depicted in FIG. 5. For example, a first computing device 500 may communicate over a network 560 with a second computing device 570 and/or a third computing device 580 hosting data stores 572 and 582. The first computing device 500 may host a reasoning system 510 that includes a reasoning engine 520 and supports a language parser 530. The reasoning engine 520 may include a real-time selection algorithm 522 and include, or have access to, a rule set 524 that includes rules parsed by the language parser 530. The network 560 may employ a number of protocols and/or configurations and may be a Local Area Network (LAN), a Wide Area Network (WAN), an intranet, the Internet, a wireless network or some other type of network allowing the first computing device 500 to communicate with the second computing device 570 and/or third computing device 580.

The present invention may be provided as one or more computer-readable programs embodied on or in one or more mediums. The mediums may be a floppy disk, a hard disk, a compact disc, a digital versatile disc, a flash memory card, a Programmable Read-Only Memory (PROM), an Magnetoresistive Random Access Memory (MRAM), a Random Access Memory (RAM), a Read-Only Memory (ROM), or a magnetic tape. In general, the computer-readable programs may be implemented in any programming language. Some examples of languages that can be used include FORTRAN, C, C++, C#, Python or Java. The software programs may be stored on or in one or more mediums as object code. Hardware acceleration may be used and all or a portion of the code may run on a Field Programmable Gate Array (FPGA), an Application Specific Integrated Circuit (ASIC) or an Application Specific Instruction Set Processor (ASIP). The code may run in a virtualized environment such as in a virtual machine. Multiple virtual machines running the code may be resident on a single processor.

One application of the real-time reasoning system is with a real-time media server. The media server pushes ads to users of associated media players based on users' activities and behaviors. The reasoning system employs recommendation marketing rules in deciding what ads to push to the users. The ads may be pushed to users during on-line activities of the users rather than after such on-line activities. A mid-tier user service may be provided to better the media player and media server.

Another application of the real-time reasoning system is to predict trends of stocks or other investment vehicles based on investment rules. The reasoning outcomes from the reasoning system are converted into new investment rules that are fed back into the reasoning system. As a result, the reasoning system can adjust to a charging investment environment. This “self-learning” capability can dramatically improve the prediction rate of an investment vehicle's trend over time.

An additional application of the real-time reasoning system is for a real-time natural language search engine interface. A parser can be used to convert English-like queries used by third party search engines (such as Google™ or Yahoo!®). Users may enter their query as an English sentence. For example, the query “tell me where I can find a Yellow Prius in Boston metropolitan in the price range of 20,000 to 25,000 dollars,” is converted into the keyword query “yellow car”, “Prius”, “Boston”, “>=$20,000” and “<=$25,000.”

A further application of the real-time reasoning system is to classify videos for object recognition using image processing rules. Conventional technology enables the extraction of basic shapes (e.g. circles, squares, triangles, etc.) from image frames in a video stream. The reasoning system recognizes in real-time the objects based on the shapes that are extracted. A list of objects found in the image frames is generated. The result is a dramatic reduction in the time resumed to classify video for specific objects.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. A computing device implemented method for providing real-time reasoning, comprising:
providing a reasoning engine supporting the use of a rule representation language having a natural language-like syntax and format, the rule representation language used to create a rule set with at least one rule for determining conclusions in a collection of data;
providing a real-time selection algorithm in the reasoning engine, the selection algorithm programmatically selecting at least one rule from the rule set; and
identifying at least one conclusion from within a collection of data using said reasoning engine and the selected at least one rule.

2. The method of claim 1, further comprising:
displaying the identified at least one conclusion and the selected at least one rule to a user.

3. The method of claim 2 further comprising:
providing a user interface displaying the rule set to a user; and
selecting, via the user interface, at least one additional rule in the rule set to be used in identifying the at least one conclusion.

4. The method of claim 1, further comprising:
creating at least one rule using said rule representation language; and
adding the created at least one rule to the rule set.

5. The method of claim 4 wherein the created at least one rule is selected by the selection algorithm and used to identify the at least one conclusion.

6. The method of claim 4, further comprising:
providing a user interface displaying the rule set to a user; and
selecting, via the user interface, at least one additional rule in the rule set to be used in identifying the at least one conclusion.

7. The method of claim 1 wherein the selection algorithm selects the at least one rule based, at least in part, on a priority value assigned to the at least one rule.

8. The method of claim 1 wherein the selection algorithm selects the at least one rule based, at least in part, on the at least one rule's absence from a previously selected set of rules.

9. The method of claim 8 wherein the selection algorithm selects the at least one rule based, at least in part, on a time stamp associated with the selected at least one rule that indicates that the selected at least one rule was previously selected less recently than a non-selected rule.

10. A physical medium holding computer-executable instructions for identifying conclusions within a collection of data, the medium comprising:
instructions providing a reasoning engine supporting the use of a rule representation language having a natural language-like syntax and format, the rule representation language used to create a rule set with at least one rule for determining conclusions in a collection of data;
instructions for providing a real-time selection algorithm in the reasoning engine, the selection algorithm programmatically selecting at least one rule from the rule set; and
instructions for identifying at least one conclusion within a collection of data using said reasoning engine and the selected at least one rule.

11. The medium of claim 10, the medium further comprising:
instructions for displaying the identified at least one conclusion and the selected at least one rule to a user.

12. The medium of claim 11 the medium further comprising:
instructions for providing a user interface displaying the rule set to a user; and
instructions for selecting, via the user interface, at least one additional rule in the rule set to be used in identifying the at least one conclusion.

13. The medium of claim 10, the medium further comprising:
instructions for creating at least one rule using said rule representation language; and
instructions for adding the created at least one rule to the rule set.

14. The medium of claim 13 wherein the created at least one rule is selected by the selection algorithm and used to identify the at least one conclusion.

15. The medium of claim 13, the medium further comprising:
instructions for providing a user interface displaying the rule set to a user; and
instructions for selecting, via the user interface, at least one additional rule in the rule set to be used in identifying the at least one conclusion.

16. The medium of claim 10 wherein the selection algorithm selects the at least one rule based, at least in part, on a priority value assigned to the at least one rule.

17. The medium of claim 10 wherein the selection algorithm selects the at least one rule based, at least in part, on the at least one rule's absence from a previously selected set of rules.

18. The medium of claim 17 wherein the selection algorithm selects the at least one rule based, at least in part, on a time stamp associated with the selected at least one rule that indicates that the selected at least one rule was previously selected less recently than a non-selected rule.

19. A system for identifying conclusions within a collection of data, comprising:
a collection of data;
a reasoning engine , the reasoning engine supporting the use of a rule representation language and including a real-time selection algorithm, the rule representation language having a natural language-like syntax and format, the selection algorithm programmatically selecting one rule written in said rule representation language in one reasoning cycle, the selected rule used to identify one conclusion using said reasoning engine at the completion of the reasoning cycle; and
a user interface, the user interface displaying the identified conclusion and the one selected rule used in identifying the conclusion at the completion of the reasoning cycle.

20. The system of claim 19 wherein the user interface enables a user to create at least one rule using said rule representation language and the created at least one rule is added to the rule set.
